(19) United States
(12) Patent Application Publication
(10) Pub. No.: US 2019/0258935 A1
(43) Pub. Date: Aug. 22, 2019

(54) COMPUTER-READABLE RECORDING MEDIUM, LEARNING METHOD, AND LEARNING APPARATUS

(71) Applicant: FUJITSU LIMITED, Kawasaki-shi (JP)

(72) Inventor: YUHEI UMEDA, Kawasaki (JP)

(73) Assignee: FUJITSU LIMITED, Kawasaki-shi (JP)

(21) Appl. No.: 16/275,487

(22) Filed: Feb. 14, 2019

(30) Foreign Application Priority Data
Feb. 19, 2018 (JP) 2018-027256

(51) Int. Cl. G06N 3/08; G06F 16/907

(52) U.S. Cl. CPC G06N 3/084; G06F 16/907

(57) ABSTRACT

A learning apparatus sets a score, for each of one or more labels assigned to each set of data to be subjected to learning, based on an attribute of the set of data to be subjected to learning, or a relation between the set of data to be subjected to learning and another set of data to be subjected to learning. The learning apparatus then causes learning to be performed with a neural network by use of the score set for the label assigned to the set of data to be subjected to learning.

### CROSS-REFERENCE TO RELATED APPLICATION

This application is based upon and claims the benefit of priority of the prior Japanese Patent Application No. 2018-027256, filed on Feb. 19, 2018, the entire contents of which are incorporated herein by reference.

### FIELD

The embodiments discussed herein are related to a learning program, a learning method, and a learning apparatus.

### BACKGROUND

Technology related to supervised learning by use of labeled data has been known. Labels used in supervised learning by use of labeled data may be labels manually assigned from a subjective viewpoint of an operator, although the labels may be labels that are certain, by which types of the data are clear from another viewpoint. Generally, labeled data are used in learning, as correct answer assigned data, for which correct answers are already known, and thus to data around a boundary between positive examples and negative examples also, either one of the labels is assigned, and learning is performed.

FIG. 12 is a diagram illustrating general assignment of labels. As illustrated in FIG. 12(a), when either a label A or a label B is to be assigned to a set of ambiguous data around a boundary, determination according to a majority decision on labels assigned to sets of data in the neighborhood of the set of ambiguous data may be performed. Furthermore, as illustrated in FIG. 12(b), since certainty of the label of the set of ambiguous data around the boundary is low, the set of ambiguous data may be removed from learned data.
Patent Literature 1: Japanese Laid-open Patent Publication No. 2015-166962
Patent Literature 2: Japanese Laid-open Patent Publication No. 2017-016414

However, according to the above described methods of assigning labels, determination accuracy of their learned results may be degraded. For example, in the method where the majority decision is used, if the labeling has been performed incorrectly, the error will be particularly increased around the boundary. Furthermore, the labels are often mingled with each other and increased in nonlinearity, and thus learning of the determiner (classifier) is difficult. In the removing method, the nonlinearity is decreased and the learning is facilitated, but since learning near the boundary is not possible, the determination accuracy around the boundary is reduced.

### SUMMARY

According to an aspect of an embodiment, a non-transitory computer-readable recording medium stores therein a learning program that causes a computer to execute a process. The process includes setting a score, for each of one or more labels assigned to each set of data to be subjected to learning, based on an attribute of the set of data to be subjected to learning, or a relation between the set of data to be subjected to learning and another set of data to be subjected to learning; and causing learning to be performed with a neural network by use of the score set for the label assigned to the set of data to be subjected to learning.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an overall example of a learning apparatus according to a first embodiment;

FIG. 2 is a diagram illustrating an example of learning according to the first embodiment;

FIG. 3 is a functional block diagram illustrating a functional configuration of the learning apparatus according to the first embodiment;

FIG. 4 is a diagram illustrating an example of information stored in a learned data DB;

FIG. 5 is a diagram illustrating an example of setting of a label by use of distributions;

FIG. 6 is a diagram illustrating an example of setting of a label by use of proportions of sets of neighborhood data;

FIG. 7 is a diagram illustrating an example of setting of a label by use of distances between sets of data;

FIG. 8 is a diagram illustrating an example of setting of a label according to crowdsourcing;

FIG. 9 is a flow chart illustrating a flow of processing;

FIG. 10 is a diagram illustrating effects;

FIG. 11 is a diagram illustrating an example of a hardware configuration; and

FIG. 12 is a diagram illustrating general label assignment.

### DESCRIPTION OF EMBODIMENTS

Preferred embodiments will be explained with reference to accompanying drawings. This invention is not limited through these embodiments. Furthermore, any of the embodiments may be combined with one another as appropriate so long as no contradictions arise therefrom.

### [a] First Embodiment

Overall Configuration

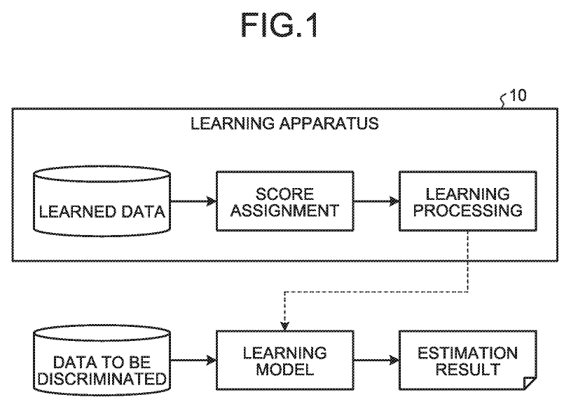

FIG. 1 is a diagram illustrating an overall example of a learning apparatus according to a first embodiment. As illustrated in FIG. 1, a learning apparatus 10 according to the first embodiment performs learning with a neural network (NN) by use of scores, so that sets of learned data are able to be discriminated (classified) per event by execution of discrimination processing (learning processing) where machine learning or deep learning (DL) is used after scores are assigned to labels of the sets of learned data. Thereafter, by use of a learning model, to which a result of the learning has been applied, accurate estimation of an event (a label) of a set of data to be discriminated is realized. Examples adoptable as the learned data include various data, such as those of images, videos, documents, and graphs.

For example, when performing learning for a model by use of the NN, the learning apparatus 10 sets a score for each of one or plural labels assigned to each set of data to be subjected to learning, based on an attribute of that set of data or a relation between that set of data and another set of data. The learning apparatus 10 causes the learning with the NN to be performed by use of the scores that have been set for the labels assigned to each set of data to be subjected to learning.

Generally, a label determined for each set of data in learning with a NN is held as a matrix. However, according to conventionally used algorithms, such as the support vector machine (SVM) algorithm, assignment to a single label is to be performed and recognition scores of all sets of learned data are most desirably 1 or 0 in accordance with correct labels; and thus 1 or 0 has been set for plural label components without decimal (fractional) values being set therefor.

That is, either 1 or 0 is set, even for a set of data which is ambiguous as to whether its label scores are 1 or 0. In other words, since either one of the labels is to be set, even for a set of data that is ambiguous as to whether its label is a label A or a label B, “a label (Label A=1.0, Label B=0.0)”, or “a label (Label A=0.0, Label B=1.0)”, is to be assigned as a label to that set of data.

Thus, according to the first embodiment, a label vector having elements corresponding to labels is assigned to a set of data ambiguous as to its label, the elements having been assigned with probabilities that the set of data will respectively have those labels, and based on such label vectors, deep learning is executed. That is, according to the first embodiment, a probabilistic label vector is assigned to a set of data ambiguous as to a label to be assigned thereto, and values of labels are learnt as decimals.

### Examples of Learning

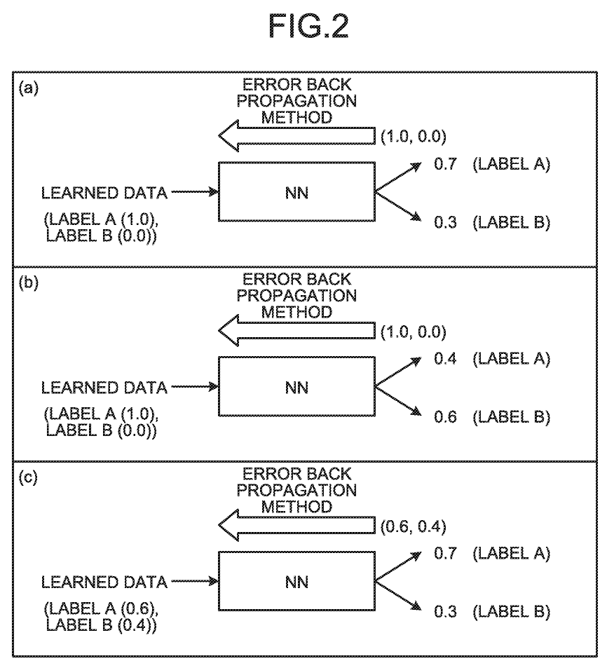

Next, learning with a set of learned data ambiguous as to its label will be described. FIG. 2 is a diagram illustrating an example of learning according to the first embodiment. FIG. 2(a) and FIG. 2(b) illustrate general learning examples, and FIG. 2(c) illustrates the example of learning according to the first embodiment.

As illustrated in FIG. 2(a), it is assumed that a set of data assigned with “Label A=1.0, Label B=0.0” is input to the NN, a probability that an output will be the label A is 70%, and a probability that an output will be the label B is 30%. In this case, learning with the NN is executed such that the set of data is discriminated as having the label A by the error back propagation method, but since the label that has been set for that set of learned data is correct to some extent, learning with the NN is able to be performed normally in a permissible range.

On the other hand, as illustrated in FIG. 2(b), it is assumed that a set of data assigned with “Label A=1.0, Label B=0.0” is input to the NN, a probability that an output will be the label A is 40%, and a probability that an output will be the label B is 60%. In this case, even though a possibility that the label that has been set for that set of learned data was wrong is high, learning with the NN is executed such that the set of data is discriminated as having the label A by the error back propagation method, the learning with the NN is performed in the wrong way, and thus degradation of the discrimination accuracy is caused.

In contrast, as illustrated in FIG. 2(c), it is assumed that a set of data assigned with “Label A=0.6, Label B=0.4” is input to the NN, a probability that an output will be the label A is 70%, and a probability that an output will be the label B is 30%. In this case, learning with the NN is executed such that the set of data is discriminated as having the label A by the error back propagation method, and since the label that has been set for that set of learned data is correct, learning with the NN is able to be performed even more normally than in the example of FIG. 2(a).

As described above, instead of causing a set of data ambiguous as to its label, to be forcibly subjected to learning to be discriminated as having either one of the labels, the learning apparatus 10 according to the first embodiment is able to execute learning in consideration of the ambiguity, with the ambiguity still remaining in that set of data. Therefore, the learning apparatus 10 enables reduction in degradation of the determination accuracy of the learned result.

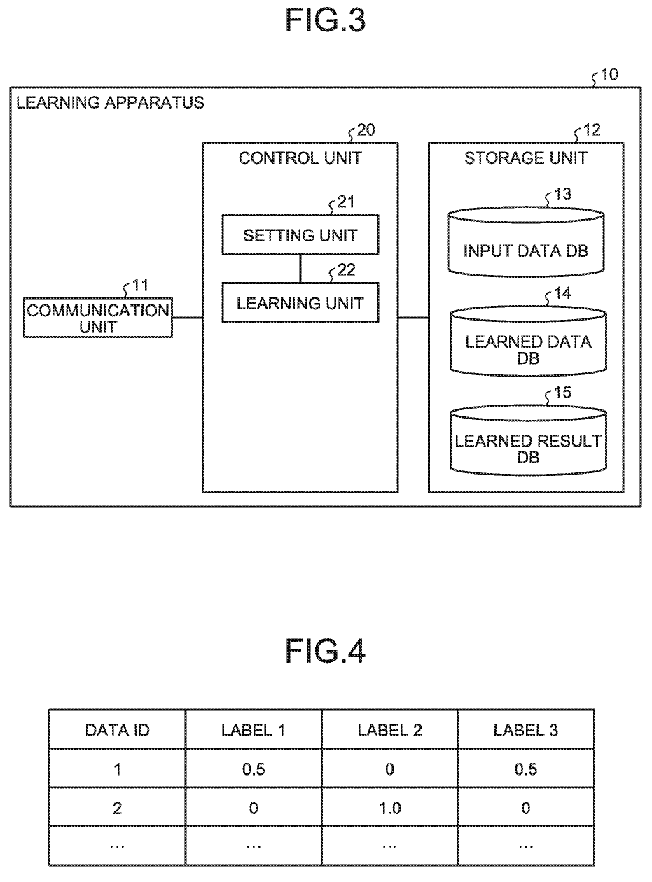

Functional Configuration FIG. 3 is a functional block diagram illustrating a functional configuration of the learning apparatus according to the first embodiment. As illustrated in FIG. 3, the learning apparatus 10 has a communication unit 11, a storage unit 12, and a control unit 20.

The communication unit 11 is a processing unit that controls communication with another apparatus, and is, for example, a communication interface. For example, the communication unit 11 receives, from a terminal of an administrator, an instruction to start processing. Furthermore, the communication unit 11 receives, from the terminal of the administrator, or the like, data to be subjected to learning (input data), and stores the data into an input data DB 13.

The storage unit 12 is an example of a storage device that stores therein a program and data, and is, for example, a memory or a hard disk. This storage unit 12 stores therein the input data DB 13, a learned data DB 14, and a learned result DB 15.

The input data DB 13 is a database where the input data to be subjected to learning are stored. For the data stored in this input data DB 13, labels may be set manually or may be unset. The data may be stored by the administrator or the like, or the communication unit 11 may receive and store the data.

The learned data DB 14 is a database where supervised data to be subjected to learning are stored. Specifically, the learned data DB 14 has the input data stored in the input data DB 13 and the labels set for those input data in association with each other by the control unit 20 described later. FIG. 4 is a diagram illustrating an example of information stored in the learned data DB 14. As illustrated in FIG. 4, the learned data DB 14 has “Data ID, Label 1, Label 2, and Label 3” stored therein in association with one another. The example in FIG. 4 indicates that a label vector, “0.5, 0, 0.5”, serving as “Label 1, Label 2, Label 3” has been set for a set of data having a data ID, “1”. The dimensionalities and numerical values of the label vectors illustrated in FIG. 4 are just examples, and these settings may be arbitrarily modified.

The learned result DB 15 is a database where results of learning are stored. For example, the learned result DB 15 has results of discrimination (results of classification) of learned data by the control unit 20, and various parameters learned by machine learning or deep learning, stored therein.

The control unit 20 is a processing unit that controls processing of the whole learning apparatus 10, and is, for example, a processor. This control unit 20 has a setting unit 21, and a learning unit 22. The setting unit 21 and the learning unit 22 are examples of electronic circuits that the processor has, or examples of processes executed by the processor.

The setting unit 21 is a processing unit that sets a score, for each of one or plural labels assigned to each set of data to be subjected to learning, based on an attribute of that set of data or a relation between that set of data and another set of data. Specifically, the setting unit 21 reads out each set of input data from the input data DB 13, and calculates a score based on that set of input data. The setting unit 21 then generates, for each set of input data, a set of learned data, for which a label vector serving as a label has been set, the label vector having scores set therefor. Thereafter, the setting unit 21 stores the generated learned data into the learned data DB 14. If a label has already been assigned manually to a set of input data, correction of the label is performed. Furthermore, by processing described later, resetting of the label may be performed for any set of ambiguous data only, or resetting of the labels may be performed for all sets of data.

That is, in the learning with the NN, the setting unit 21 solves the harmful effect due to the application of the premise that “the confidence factors or reliabilities” of sets of data that have been labeled are “all correct”, by use of decimal labels (label vectors). A specific example of a method of setting labels executed by the setting unit 21 will be described. The description will be made by use of a case where there are two labels (a two-dimensional case), but not being limited to this case, processing may be performed similarly even if the dimensionality is three or higher. For example, the setting unit 21 may determine a set of data that has been labeled differently by plural users, such as administrators, to be a set of ambiguous data.

First Technique: Distribution Firstly, an example where a score is set based on a mixture ratio in mixed distributions including plural distributions when an attribute of a set of ambiguous data follows the mixed distributions will be described. That is, a technique where it is assumed that occurrence of each label is along a certain distribution and decision is made based on mixed distributions of each label will be described. In this example, it is assumed that distances between respective sets of data have been determined, the number of sets of data present is sufficient, and labels including ambiguous labels have been assigned to all of the sets of data.

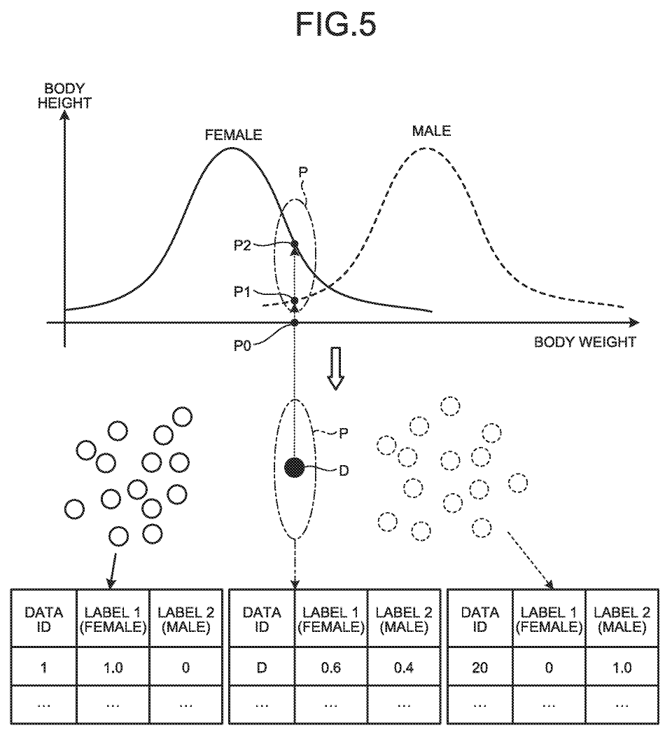

FIG. 5 is a diagram illustrating an example of setting of labels by use of distributions. This example is an example where a gender is identified from numerical values of body heights and body weights of the same generation. Body heights and weights are measured by sensors, and a case where labeling is performed visually or a case where labeling is performed automatically along the distributions will be considered. As illustrated in FIG. 5, distributions of body heights and weights that have been normalized are expected to follow normal distributions, and males have higher average body height and weight.

In the example of FIG. 5, sets of data that are only along the female normal distribution are represented by circles, and sets of data that are only along the male normal distribution are represented by dotted lined circles. For example, the setting unit 21 sets a label vector, “Label 1 (female)=1.0, Label 2 (male)=0.0”, for a set of data (ID=1) in a region where the normal distributions do not overlap each other, the region belonging to the female normal distribution. Furthermore, the setting unit 21 sets a label vector, “Label 1 (female)=0.0, Label 2 (male)=1.0”, for a set of data (ID=20) in a region where the normal distributions do not overlap each other, the region belonging to the male normal distribution.

The setting unit 21 sets scores serving as labels and based on proportions or the like of the mixed distributions, for a set of data (ID=D) belonging to a region P where the distributions overlap each other, that is, for a set of data D that is ambiguous. For example, the setting unit 21 identifies a value P2 on the female distribution and a value P1 on the male distribution, and calculates proportions of a distance from P0 to P1 (P1−P0) and a distance from P0 to P2 (P2−P0). When the setting unit 21 calculates that “distance (P2−P0):distance (P1−P0)”=“6:4”, the setting unit 21 sets a label vector, “Label 1 (female)=0.6, Label 2 (male)=0.4” for the set of data D.

The setting unit 21 determines each set of data belonging to both of the distributions, in other words, each set of data that is along both of the distributions, as a set of ambiguous data, and calculates a score thereof by the above described processing. When calculating the proportions, the setting unit 21 may perform normalization such that the total equals “1”. Furthermore, not being limited to the distances, proportions or ratios of the values themselves (the body weights in FIG. 5) may be used. Moreover, for any set of data that is along either one of the distributions, a label may be set manually by the administrator or the like, and label setting according to the above described first technique may be executed only for any set of ambiguous data.

Second Technique: Proportions of Neighborhood Data Next, an example where a label is set for a set of ambiguous data, based on proportions of labels assigned to sets of data in the neighborhood of that set of ambiguous data will be described. In this example also, similarly to the first technique, it is assumed that distances between respective sets of data have been determined, the number of sets of data present is sufficient, and labels including ambiguous labels have been assigned to all of the sets of data. If the dimensionality of the data is three or higher, distances between all sets of data are calculated, and dimensionality compression to two-dimensionality is performed by multi-dimensional scaling (MDS).

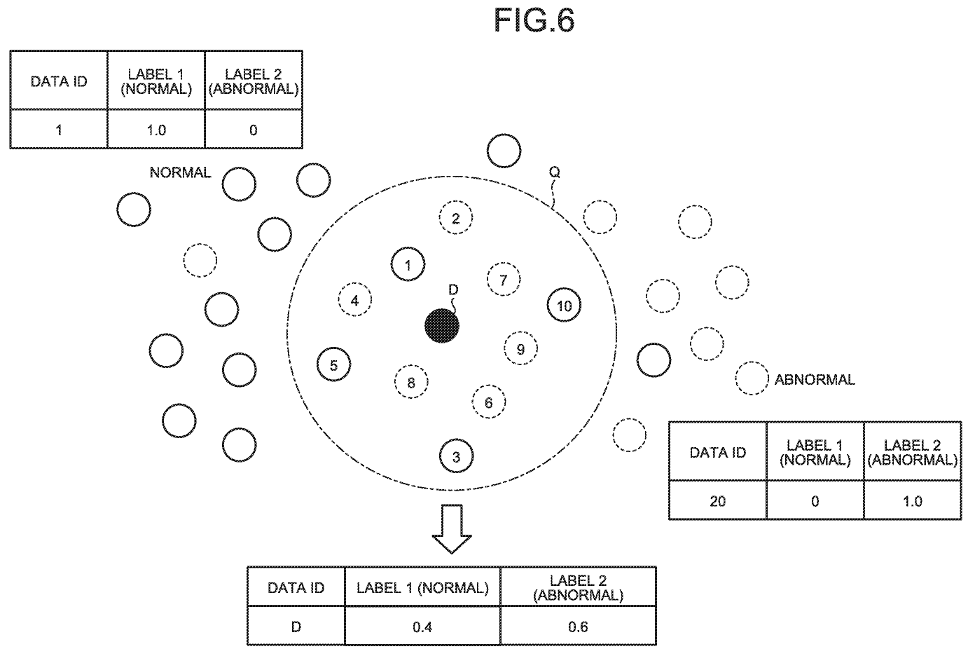

FIG. 6 is a diagram illustrating an example of setting of labels by use of proportions of sets of neighborhood data. This example is an example where whether a device is normal or abnormal is determined from vibration of each part of the device upon operation of the device, and labels indicating whether sets of data that are sets of vibration data of the respective parts of the device are normal or abnormal are set. Since abnormality of devices occurs as degradation over time, determination at a boundary between normality and abnormality is highly uncertain. Furthermore, determination around the boundary is often ambiguous, and normal and abnormal data do not respectively follow distributions.

In the example of FIG. 6, sets of data determined to be normal values are represented by circles, and sets of data determined to be abnormal values are represented by dotted lined circles, based on past cases and failure cases that have actually occurred. For example, the setting unit 21 sets a label vector, “Label 1 (normal)=1.0, Label 2 (abnormal)=0.0”, for a set of data (ID=1) determined to be a normal value. Furthermore, the setting unit 21 sets a label vector, “Label 1 (normal)=0.0, Label 2 (abnormal)=1.0” for a set of data (ID=20) determined to be an abnormal value.

In contrast, the setting unit 21 performs label setting based on proportions of labels of other sets of data present in the neighborhood within a threshold distance on a compression space, for a set of ambiguous data (ID=D), for which the determination of whether it is a normal value or an abnormal value is not possible from the past cases and the like. Numbers in the circles of FIG. 6 represent data IDs.

As illustrated in FIG. 6, by using distances between sets of data obtained by MDS or the like, the setting unit 21 identifies sets of data present in an arbitrary predetermined range Q from the ambiguous set of data D. Among the sets of data in the predetermined range Q, the setting unit 21 identifies that labels of four sets of data having data IDs 1, 3, 5, and 10 are “normal”, and labels of six sets of data having data IDs 2, 4, 6, 7, 8, and 9 are “abnormal”. That is, the setting unit 21 determines that four out of the ten sets of neighborhood data in the predetermined range Q have been identified to be “normal”, and six out of the ten sets of neighborhood data have been identified to be “abnormal”. As a result, the setting unit 21 sets a label vector, “Label 1 (normal)=0.4, Label 2 (abnormal)=0.6” for the set of data D.

The setting unit 21 is able to determine, as a set of ambiguous data, for example: a set of data determined to be unable to be distinguished as to whether the set of data is normal or abnormal by a user, such as the administrator; or a set of data determined as not belonging to normality nor abnormality based on the past cases. Upon the calculation of the proportions, normalization may be performed such that the total equals “1”. Furthermore, for any set of data that has been determined accurately as to whether the set of data is normal or abnormal, a label may be set manually by the administrator or the like, and label setting according to the above described second technique may be executed only for any set of ambiguous data.

Third Technique: Distances Between Sets of Data

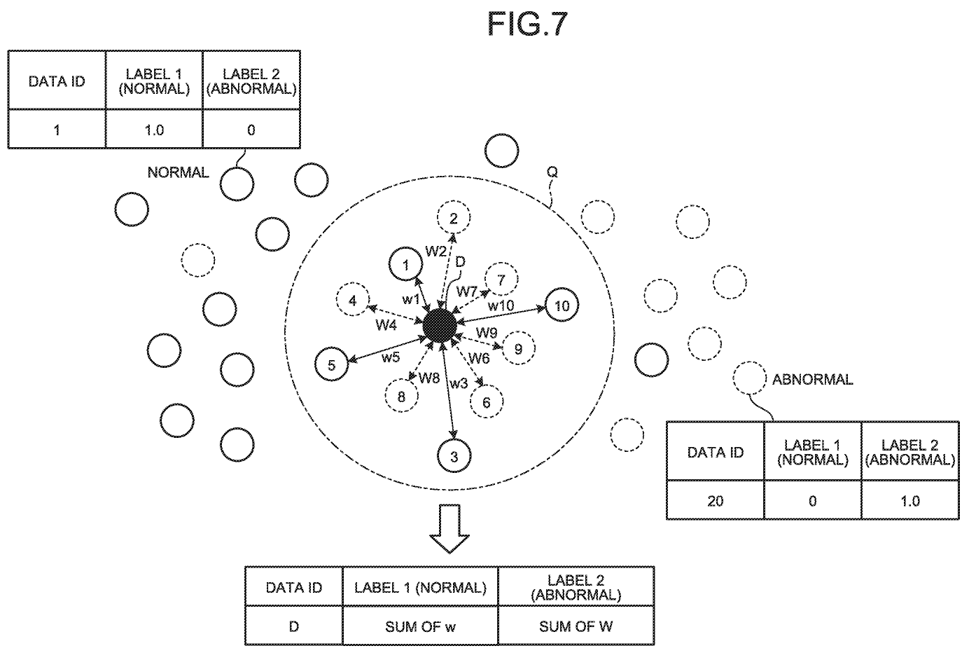

Next, an example where a label is set for a set of ambiguous data, based on distances between the set of ambiguous data and sets of data in the neighborhood of the set of ambiguous data will be described. Conditions in this example are similar to those of the second technique. FIG. 7 is a diagram illustrating an example of setting of labels by use of distances between sets of data.

As illustrated in FIG. 7, by using distances between sets of data obtained by MDS or the like, the setting unit 21 identifies sets of data present in an arbitrary predetermined range Q from a set of ambiguous data D. Among the sets of data in the predetermined range Q, the setting unit 21 identifies four sets of data having data IDs 1, 3, 5, and 10 that have been identified to be “normal” (assigned with normal labels only). Subsequently, by using the distances between the sets of data that have been calculated beforehand, the setting unit 21 calculates a distance w1 between the sets of data D and the set of data 1, a distance w3 between the set of data D and the set of data 3, a distance w5 between the set of data D and the set of data 5, and a distance w10 between the set of data D and the set of data 10. Thereafter, the setting unit 21 calculates, as a weight according to the distances (the sum of w), “(1/w1)+(1/w3)+(1/w5)+(1/w10)”. Reciprocals of the distances are used in this calculation of the weight, but any index that increases as the distance decreases may be used instead.

Similarly, among the sets of data in the predetermined range Q, the setting unit 21 identifies six sets of data having data IDs 2, 4, 6, 7, 8, and 9 that have been identified to be “abnormal” (assigned with abnormal labels only). Subsequently, by using the distances between the sets of data that have been calculated beforehand, the setting unit 21 calculates a distance W2 between the set of data D and the set of data 2, a distance W4 between the set of data D and the set of data 4, a distance W6 between the set of data D and the set of data 6, a distance W7 between the set of data D and the set of data 7, a distance W8 between the set of data D and the set of data 8, and a distance W9 between the set of data D and the set of data 9. Thereafter, the setting unit 21 calculates, as a weight according to the distances (the sum of W), “(1/W2)+(1/W4)+(1/W6)+(1/W7)+(1/W8)+(1/W9)”.

As a result, the setting unit 21 sets, as a label vector, “Label 1 (normal), Label 2 (abnormal)”, “Label 1 (normal=sum of w, Label 2 (abnormal)=sum of W”, for the set of data D. This calculation technique in consideration of weights of distances is just an example, and any technique where importance is more attached as the distance decreases may be adopted. Furthermore, a weight according to distances may be calculated by performing normalization such that the total equals “1”. Moreover, with the second technique and third technique, the probabilities (values) calculated for all sets of data as described above do not form a smooth function, and thus a response surface may be generated for each label, and a value according to the response surface of each label may be associated with a cell value of a vector.

Fourth Technique: Proportions of Neighborhood Data

Next, an example where a label is set, based on proportions of labels specified by reference information when plural pieces of information serving as reference for label determination are present will be described. For example, requesting labeling operation to plural persons in charge by crowdsourcing may be considered. In that case, a label of each set of data is determined from their respective labeling results, but a set of ambiguous data may be assigned with different labels by the persons in charge.

Generally, the determination is made by a majority decision or according to reliability of the persons in charge, but a correct label is not always assigned thereby. Thus, the setting unit 21 generates and sets a label vector based on proportions of labeling results.

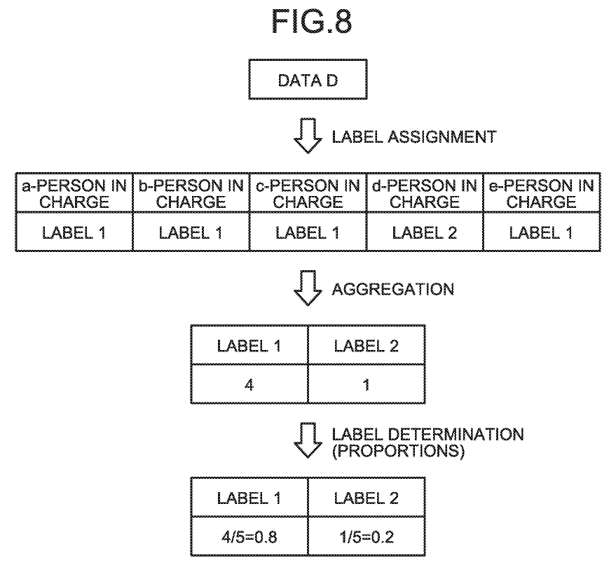

FIG. 8 is a diagram illustrating an example of setting of labels by crowdsourcing. As illustrated in FIG. 8, it is assumed that an a-person in charge assigns a label 1, a b-person in charge assigns the label 1, a c-person in charge assigns the label 1, a d-person in charge assigns a label 2, and an e-person in charge assigns the label 1. In this case, the setting unit 21 calculates the total set count of each label, and calculates the total set count for the label 1 to be “4”, and for the label 2 to be “1”. The setting unit 21 then calculates “⅘=0.8, ⅕=0.2” as proportions of the labels to the whole, “Label 1, Label 2”. As a result, the setting unit 21 sets a label vector, “Label 1=0.8, Label 2=0.2” for a set of data D.

Weighting may be performed according to, for example, the reliability of the persons in charge. For example, if a reliability of the a-person in charge specified beforehand is equal to or greater than a threshold, even if the set count for the a-person in charge is 1, the above described technique may be executed by determination of the set count as 2 by doubling of the set count of 1. Furthermore, if labels specified by the reference information are different from one another, weighting may be performed according to importance of the reference information, and “a weighted ratio of each label” resulting from division of a weighted sum of information specifying each label by a weighted sum of the whole may serve as a value for each label.

The learning unit 22 in FIG. 3 is a processing unit that executes learning with the NN by using learned data stored in the learned data DB 14, and stores results of the learning into the learned result DB 15. In the example of FIG. 4, the learning unit 22 executes learning, with the label vector, “Label 1=0.5, Label 2=0, Label 3=0.5”, serving as an input, for the set of data with the ID=1.

Flow of Processing

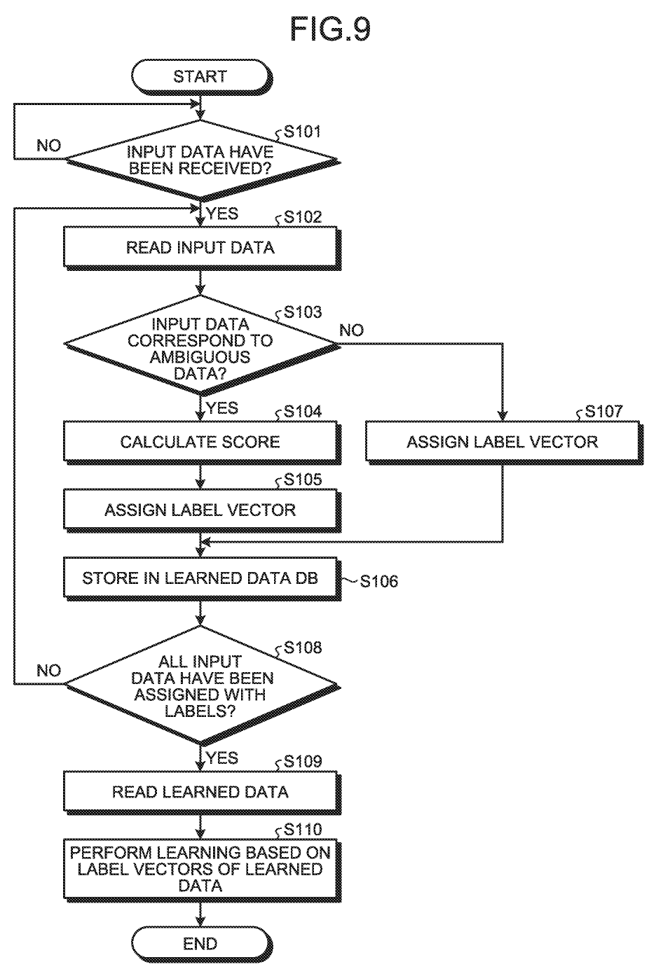

Next, the above described processing for setting of a label vector will be described. FIG. 9 is a flow chart illustrating a flow of the processing.

As illustrated in FIG. 9, when input data have been received and stored in the input data DB 13 (S101: Yes), the setting unit 21 reads one set of input data from the input data DB 13 (S102).

Subsequently, the setting unit 21 determines whether or not the read set of input data corresponds to a set of ambiguous data (S103); and if the read set of input data corresponds to a set of ambiguous data (S103: Yes), the setting unit 21 calculates a score from an attribute of the set of input data or a relation between the set of input data and another set of data (S104). The setting unit 21 then generates a set of learned data resulting from setting (assignment) of a label vector based on the score for (to) the set of input data (S105), and stores the set of learned data into the learned data DB 14 (S106).

On the contrary, if the read set of input data does not correspond to a set of ambiguous data (S103: No), the setting unit 21 generates a set of learned data resulting from setting of a label vector representing a known label for the set of input data (S107), and stores the set of learned data into the learned data DB 14 (S106). A label that has been already assigned to a set of unambiguous input data is able to be used as is.

Thereafter, if labels (label vectors) for all sets of input data have not been set, and any set of unset input data is available (S108: No), processing from S102 is executed.

On the contrary, if labels (label vectors) have been set for all sets of input data (S108: Yes), the learning unit 22 reads each set of learned data from the learned data DB 14 (S109), and executes learning based on a label vector of each set of learned data (S110).

Effects

As described above, when an assigned label is ambiguous, the learning apparatus 10 is able to perform deep learning and perform highly accurate learning by assigning a probabilistic label vector. Furthermore, the learning apparatus 10 is able to reduce degradation of the discrimination speed and degradation of the discrimination accuracy of the learned result, which are caused by aggregation of labels.

Results of experiments where the techniques according to the first embodiment were compared with related techniques will be described. Firstly, conditions of the experiments will be described. An example where a set of data is classified as a positive example or a negative example based on whether or not a first component is equal to or greater than 0.5 by using ten-dimensional vector data will be described. As conditions for ambiguous data, for any set of data where its first component is between 0.35 and 0.55, its label is changed randomly at a probability of three out of ten.

The techniques compared are: a “first general technique” where learning is performed with labels as is; a “second general technique” where labels are replaced according to subjectivity of a person in charge; “uncertainty removal” where any set of data of an interval (from 0.35 to 0.6) that is an uncertain interval is removed from learned data; and “the first embodiment” where any one of the above described first to fourth techniques is used.

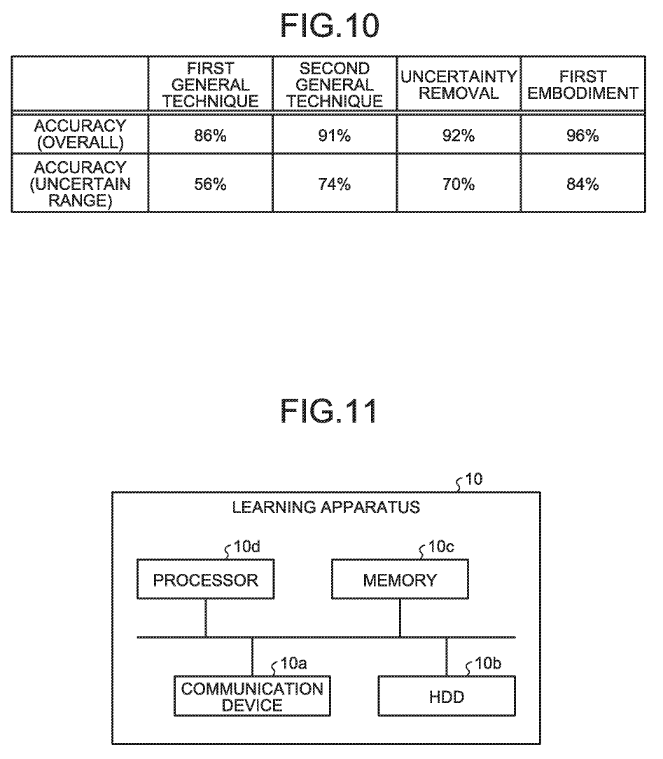

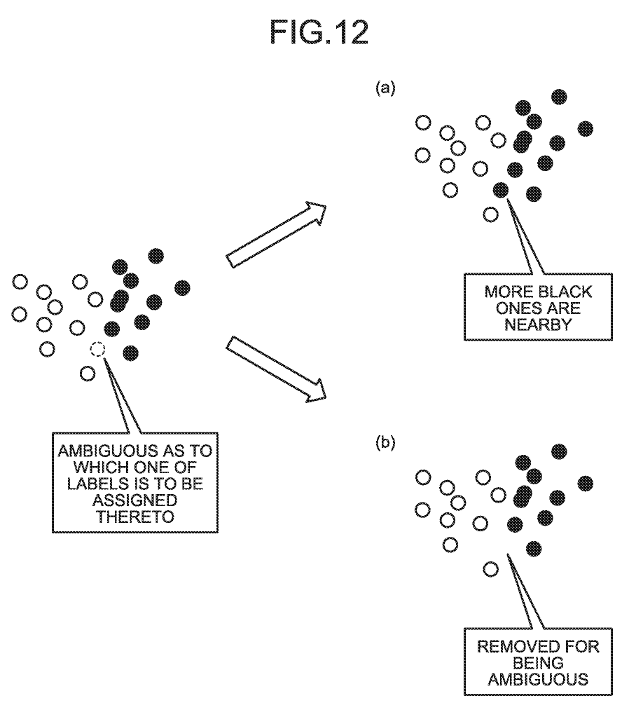

FIG. 10 is a diagram illustrating effects. FIG. 10 illustrates results of execution of discrimination of data to be discriminated by execution of learning after generation of learned data by each technique and use of a learning model reflecting results of the learning thereafter. As illustrated in FIG. 10, as to the overall accuracy, each technique enabled highly accurate discrimination (classification), but accuracy of each technique for the uncertain range (the interval from 0.35 to 0.6) was decreased therefrom. However, with the first embodiment, although the accuracy was decreased, an accuracy of 80% or higher was still maintained, and it has thus been found out that discrimination was able to be performed highly accurately. Therefore, even when compared with the other techniques, the first embodiment enables reduction in degradation of the discrimination accuracy of the learned result.

### [b] Second Embodiment

Although one embodiment of the present invention has been described thus far, the present invention may be implemented in various different modes, other than the above described embodiment.

System

The processing procedure, the control procedure, the specific names, and the information including the various data and parameters, which have been described above and illustrated in the drawings may be arbitrarily modified unless otherwise particularly stated. Furthermore, the specific examples, distributions, and numerical values described with respect to the embodiment are just examples, and may be arbitrarily modified.

Furthermore, the components of each device have been functionally and conceptionally illustrated in the drawings, and may be not configured physically as illustrated in the drawings. That is, specific modes of separation and integration of the devices are not limited to those illustrated in the drawings. That is, all or a part of these devices may be configured by functional or physical separation or integration thereof in arbitrary units according to various loads and use situations. Moreover, all or any part of the processing functions performed in the devices may be realized by a CPU and a program analyzed and executed by the CPU, or may be realized as hardware by wired logic.

Hardware

FIG. 11 is a diagram illustrating an example of a hardware configuration. As illustrated in FIG. 11, the learning apparatus 10 has a communication device 10a, a hard disk drive (HDD) 10b, a memory 10c, and a processor 10d. Furthermore, these units illustrated in FIG. 11 are connected to one another via a bus or the like.

The communication device 10a is a network interface card or the like, and performs communication with another server. The HDD 10b stores therein: a program that causes the functions illustrated in FIG. 3 to run; and the databases.

The processor 10d causes a process executing the functions described with reference to FIG. 3 and the like to run, by loading a program executing processing similar to that of the processing units illustrated in FIG. 3, from the HDD 10b or the like, into the memory 10c. That is, this process executes functions that are the same as those of the processing units that the learning apparatus 10 has. Specifically, the processor 10d reads a program having functions that are the same as those of the setting unit 21, the learning unit 22, and the like, from the HDD 10b or the like. The processor 10d then executes a process that executes processing that is the same as that of the setting unit 21, the learning unit 22, and the like.

As described above, the learning apparatus 10 operates as an information processing apparatus that executes a learning method, by reading out and executing the program. Furthermore, by reading out the program from a recording medium through a medium reading device and executing the program read out, the learning apparatus 10 is also able to realize functions that are the same as those of the above described embodiment. The program referred to herein is not limited to being executed by the learning apparatus 10. For example, the present invention may be similarly applied to a case where another computer or a server executes the program, or a case where that computer and the server execute the program in corporation with each other.

According to the embodiments, degradation of determination accuracy of a learned result is able to be reduced.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a learning program that causes a computer to execute a process comprising:
setting a score, for each of one or more labels assigned to each set of data to be subjected to learning, based on an attribute of the set of data to be subjected to learning, or a relation between the set of data to be subjected to learning and another set of data to be subjected to learning; and
causing learning to be performed with a neural network by use of the score set for the label assigned to the set of data to be subjected to learning.

2. The non-transitory computer-readable recording medium according to claim 1, wherein the process further comprises:
when the attribute of the set of data to be subjected to learning follows mixed distributions including plural distributions, setting the score based on a mixture ratio in the mixed distributions.

3. The non-transitory computer-readable recording medium according to claim 1, wherein the process further comprises:
identifying each of sets of neighborhood data to be subjected to learning that are positioned within a predetermined distance from the set of data to be subjected to learning, and setting the score based on proportions of labels assigned to the sets of neighborhood data to be subjected to learning.

4. The non-transitory computer-readable recording medium according to claim 1, wherein the process further comprises:
identifying each of sets of neighborhood data to be subjected to learning that are positioned within a predetermined distance from the set of data to be subjected to learning, and setting the score by using:
proportions of labels assigned to the sets of neighborhood data to be subjected to learning; and
a weight according to distances between the set of data to be subjected to learning and the sets of neighborhood data to be subjected to learning.

5. A learning method comprising:
setting a score, for each of one or more labels assigned to each set of data to be subjected to learning, based on an attribute of the set of data to be subjected to learning, or a relation between the set of data to be subjected to learning and another set of data to be subjected to learning, using a processor; and
causing learning to be performed with a neural network by use of the score set for the label assigned to the set of data to be subjected to learning, using the processor.

6. A learning apparatus comprising:
a memory; and
a processor coupled to the memory and the processor configured to:
set a score, for each of one or more labels assigned to each set of data to be subjected to learning, based on an attribute of the set of data to be subjected to learning, or a relation between the set of data to be subjected to learning and another set of data to be subjected to learning; and
cause learning to be performed with a neural network by use of the score set for the label assigned to the set of data to be subjected to learning.
